(19) United States
(12) Patent Application Publication
(10) Pub. No.: US 2006/0225593 A1
(43) Pub. Date: Oct. 12, 2006

(54) Method for making a label

(76) Inventors: Timothy J. Flynn, Key Largo, FL (US); Thomas E. Flynn, Crystal Lake, IL (US); Patrick J. Flynn, Redlands, CA (US)

Correspondence Address: Douglas H. Pauley;Pauley Petersen & Erickson, Suite 365, 2800 West Higgins Road, Hoffman Estates, IL, 60195, US

(21) Appl. No.: 11/100,324

(22) Filed: Apr. 6, 2005

(51) Int. Cl. B41F 33/00

(52) U.S. Cl. 101/483

(57) ABSTRACT

A method for making a label including routing a label assembly including a back sheet and a face sheet through a printer. The face sheet includes a carrier portion and at least one label. Information is printed on a first printable surface of a first side portion of the label. The label is separated from the carrier portion along a line of separation formed between the label and the carrier portion as the label is removed from the back sheet. A first side portion of the label is folded with respect to a second side portion of the label along a fold line positioned between the first side portion and the second side portion. A first void formed in the first side portion is generally aligned with a second void formed in the second side portion.

### BACKGROUND OF THE INVENTION

1. Field of the Invention

This invention is directed to a label assembly including at least one label having at least one printable surface. The label is mountable with respect to an object. More particularly, this invention is directed to method for making a label that is mountable about a neck portion of a bottle to provide information related to the contents of the bottle upon which the label is mounted.

2. Description of Related Art

Wines are typically bottled and each bottle stored in a compartment within a wine rack. Wine racks preferably maintain each bottle in a generally horizontal or laid-flat position within the individual compartment in an organized configuration. With each bottle positioned within a compartment of the wine rack, the label on the bottle cannot be read without removing the bottle from within the wine rack compartment.

Accordingly, a need exists for a tag or label that can be mounted or position on or adhered to a bottle to indicate information related or relevant to the contents of the bottle that is visible without removing the bottle from the wine rack. A need also exists for a tag or label that can be easily identified and/or organized. A further need exists for a tag or label assembly that can be easily manufactured and assembled to form a tag or label having a printable surface on which the related or relevant information can be printed.

### SUMMARY OF THE INVENTION

It is an object of the present invention to provide a label that can be mounted or positioned about an object, such as a label forming a void for mounting the label on a neck portion of a bottle.

It is a further object of the present invention to provide a label having at least one printable surface that contains information to identify and/or indicate relevant information related to the object to which the label is associated.

The above and other objects of this invention can be attained with a method for making a label having a void for mounting the label on an object, such as a neck portion of a wine bottle. A label assembly is routed through a suitable printer. Information downloaded from an internet website or saved on a computer database for example, is printed on at least one printable surface of a first side portion and/or on at least one printable surface of a second side portion of the label. Additionally, or alternatively, information can be printed on a printable surface of at least one second label.

After the label assembly is routed through the printer to print on the label the desired or selected information, the label is separated from the carrier portion along at least one line of separation formed between the label and the carrier portion. The label is removed from the back sheet with the adhesive layer initially positioned between the back sheet and the face sheet adhering substantially to a back surface of the label. Thus, the adhesive coating at least partially covers a back surface of the label. Preferably, as the label is removed from the back sheet, a first removable panel is removed from the first side portion to form a first void and a second removable panel is removed from the second side portion to form a second void. The first removable panel is preferably cut within a first shape at least partially defined by the first side portion on the face sheet, and the second removable panel is preferably cut within a second shape at least partially defined by the second side portion on the face sheet. In certain embodiments of this invention, the first removable panel and/or the second removable panel can be removed from the label before or after the label is removed from the back sheet.

The label is folded along a fold line positioned between and connecting the first side portion and the second side portion with the first void formed in the first side portion generally aligned with the second void formed in the second side portion. With the label in the folded position, the back surface of the first side portion can be adhesively bonded or adhered to the back surface of the second side portion by applying suitable pressure to the label. With the label folded along the fold line, a first outer periphery of the first side portion is preferably coextensive with a second outer periphery of the second side portion.

In one preferred embodiment of this invention, a first removable section is aligned with a second removable section as the first void is aligned with the second void. The first removable section is defined between two tearable lines of separation each extending between the first outer periphery and a perimeter of the first void. The second removable section is defined between two tearable lines of separation each extending between the second outer periphery and a perimeter of the second void. The first removable section is removed from the first side portion. The second removable section is removed from the second side portion. The first removable section and/or the second removable section can be removed before or after the second side portion is folded with respect to the first side portion to form the label.

In certain embodiments of this invention, slits formed in the first side portion are aligned with slits formed in the second side portion. For example, the first side portion preferably, but not necessarily, includes a plurality of slits extending radially outwardly from the perimeter of the first void. Similarly, the second side portion includes a plurality of slits extending radially outwardly from the perimeter of the second void and corresponding generally to the first plurality of slits.

In another preferred embodiment of this invention, a first opening is formed between the first outer periphery of the first side portion and the perimeter of the first void. Preferably, the first opening is formed as the label is removed from the back sheet. With the label removed from the back sheet and separated from the carrier portion, the first opening communicates with the first void. Preferably, the second opening is formed between the second outer periphery and the perimeter of the second void. A position of the second opening with respect to the perimeter of the second void preferably corresponds to a position of the first opening with respect to the perimeter of the first void. With the label removed from the back sheet and separated from the carrier portion, the second opening communicates with the second void. With the label in the folded position, the first opening is generally aligned with the second opening.

The second label can also be removed from the label assembly. The second label can be separated from the carrier portion and removed from the back sheet and with respect to the carrier portion along a line of separation. The second label is removed from the back sheet with the adhesive layer initially positioned between the back sheet and the face sheet adhering substantially to a back surface of the second label. Thus, the adhesive coating at least partially covers a back surface of the second label. The second label can then be adhered to a surface, such as a bottom surface of a wine bottle.

Other objects and advantages of this invention are apparent to those skilled in the art, in view of the following detailed description taken in conjunction with the appended claims and drawings.

### BRIEF DESCRIPTION OF THE DRAWINGS

The present invention can be better understood with reference to the following drawings. In the drawings, like reference numerals designate corresponding parts throughout the several views. The drawings are not necessarily to scale and emphasis is placed upon clearly illustrating principles of the present invention.

FIG. 1 is a plan view of a label assembly including a plurality of labels, according to one preferred embodiment of this invention;

FIG. 2 is a plan view of a label assembly including a plurality of labels having information printed on a first side portion and a second side portion of each label, according to one preferred embodiment of this invention;

FIG. 3 is a front view of a label in an unfolded position, according to one preferred embodiment of this invention;

FIG. 4 is a front view of a label mounted to a neck portion of a bottle, according to one preferred embodiment of this invention;

FIG. 5 is a perspective view of a label mounted to a neck portion of a bottle, according to one preferred embodiment of this invention; and

FIG. 6 is a bottom view of a bottle having a second label attached to a surface of the bottle and including information corresponding to information printed on a first label, according to one preferred embodiment of this invention.

### DETAILED DESCRIPTION OF PREFERRED EMBODIMENTS

The present invention is directed to a label assembly having a back sheet and a face sheet removably adhered to the back sheet. The face sheet includes a carrier portion and at least one label that is removable from the back sheet and separable from the carrier portion. The label includes connected side portions that can be folded with respect to one another and adhesively bonded together to form a label to align voids formed in each side portion. The label also includes at least one printable surface upon which information can be printed to identify an object on which the label is mounted or positioned.

The labels made according to the present invention can be positioned about a neck portion of a bottle, such as a wine bottle 99, or other suitable container and may contain any suitable or relevant information. Such information may include an image, print, picture, drawing, letter, number, word and/or symbol, for example, to identify the contents of the bottle and provide related or relevant information. The label can be positioned about a stem of a wine glass or other glass or cup to identify the person to whom the glass belongs or the label can be hung on a closet hanger or hook to identify relevant information regarding the garment or article corresponding to the label. Although the following description of this invention generally refers to a label that can be positioned about a neck portion of a wine bottle to identify relevant information pertaining to such facts as the maker of the wine, the year in which the wine was produced, the purchase price, an inventory number and/or a year the bottle was acquired, it is apparent to those skilled in the art that the labels made according to the present invention can be used for any suitable or desired purpose.

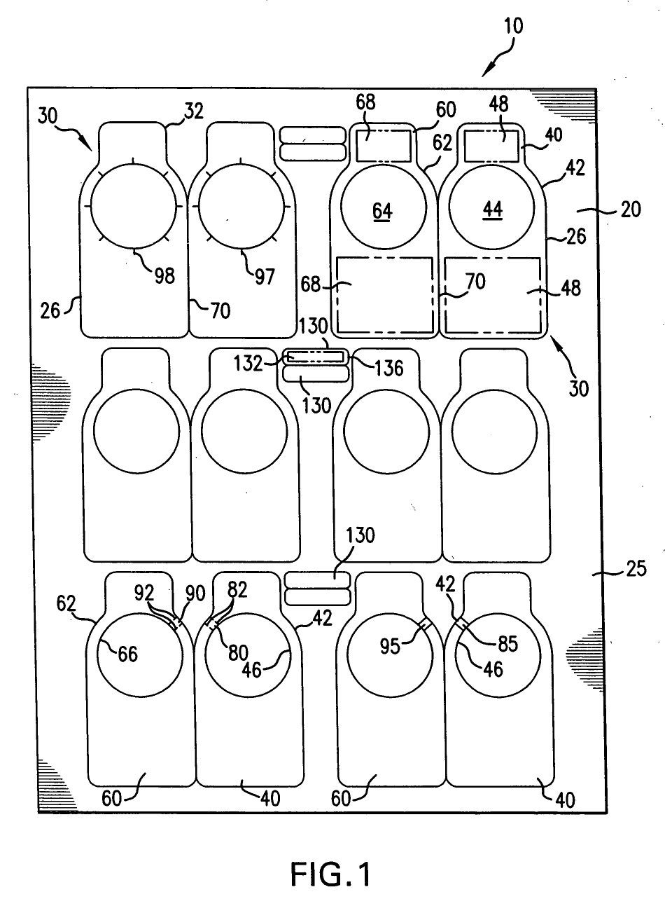

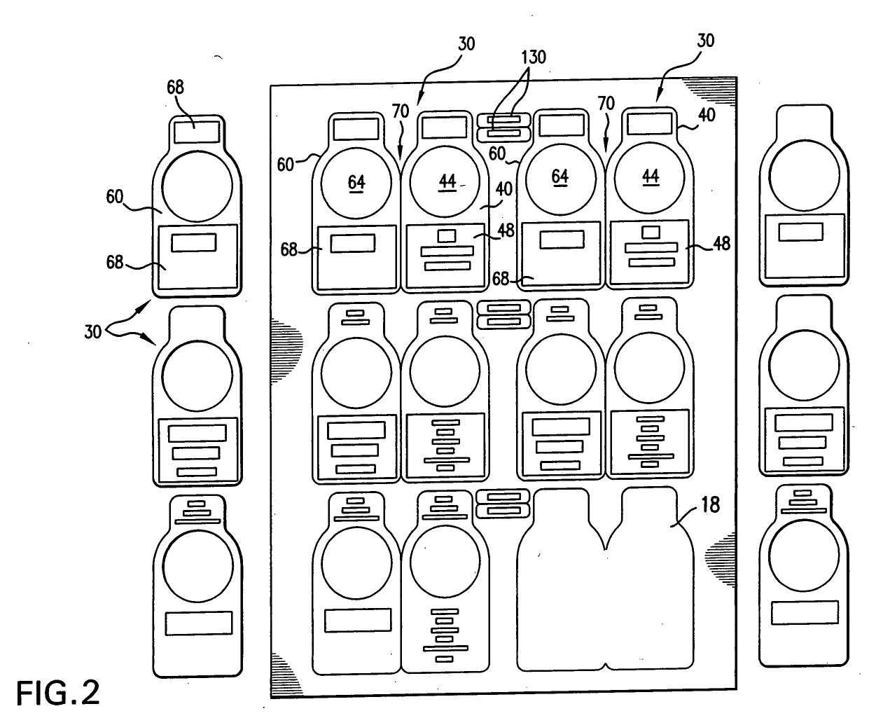

FIGS. 1 and 2 illustrate a label assembly 10 according preferred embodiments of this invention. Referring generally to FIGS. 1 and 2, label assembly 10 is of any suitable shape, and generally any suitable size that can be accepted by and fed through a printer, such as a laser printer or an ink jet printer. Common sizes of paper generally fed through printers are 8.5 inches by 5.5 inches, 8.5 inches by 11 inches, 8.263 inches by 11.688 inches (A4 size), and 8.5 inches by 14 inches. Label assembly 10 preferably includes a back sheet 18, as shown in FIG. 2, and a face sheet 20 with a layer of adhesive between back sheet 18 and face sheet 20.

Back sheet 18 of label assembly 10 preferably includes one side having a treated surface to facilitate removal of face sheet 20 relative to back sheet 18. More specifically, the removal of a label 30 from back sheet 18 is facilitated by the treated surface. Preferably, a substantial portion of the adhesive layer remains with label 30 as it is removed from back sheet 18. As shown in FIGS. 1 and 2, back sheet 18 is preferably generally coextensive with face sheet 20. FIG. 2 shows a portion of back sheet 18 with one label 30 removed from back sheet 18.

Face sheet 20 is preferably, but not necessarily, constructed of any suitable paper, paper composite, non-metal, metal material and/or any other suitable material that can be used as a label. Other suitable materials for constructing face sheet 20 include fabric, plastic, and metal foils. An adhesive coating is applied, in any suitable manner known to those skilled in the art, to one side of face sheet 20. Face sheet 20 preferably has at least one printable surface on a side opposite the adhesive side. The printable surface on face sheet 20 can be any of a variety of face materials used to make pressure sensitive, or self-adhesive labels. Such face materials may include, but are not limited to smudgeproof stock, litho stock, cast coated stock, tag stock, fluorescent stock, foils, computer printable polyester, vinyl, satin cloth, Tyvek™ material, flexible plastic, book papers, photo quality papers and/or photo quality film.

As used throughout this specification and in the claims, the term printable surface relates to a surface of any type of matter upon which a person or machine can draw, print, color, paint, photocopy, write, emboss or make any other type of mark or graphic. Laser printers, ink jet printers, impact printers, thermal transfer printers, direct thermal printers, typewriters or any other suitable graphic printing devices are preferred, but not necessary, for use with printable surfaces according to this invention.

As briefly described above, a layer of an adhesive is preferably positioned between back sheet 18 and face sheet 20 so that the adhesive adheres to face sheet 20 exclusively or at least adheres to face sheet 20 more than to back sheet 18 when face sheet 20 is removed from back sheet 18. As a result of this configuration, label assembly 10 includes face sheet 20 having a printable side and an opposite, adhesive side and back sheet 18 including a separable side and an opposite side.

Face sheet 20 includes a carrier portion 25 and at least one label 30. Label 30 is preferably pre-cut or shaped into a desired form for application in a desired manner, such as a bottle neck label. At least one line of separation 26 is formed between each label 30 and carrier portion 25 to define an outer periphery 32 of each label 30. Preferably, line of separation 26 is die-cut along at least a portion of a periphery of a first side portion 40 of label 30 and at least a portion of a periphery of second side portion 60 of label 30. Label 30 is removable from back sheet 18 and removable with respect to carrier portion 25 along line of separation 26.

Referring further to FIGS. 3-5, label 30 includes a first side portion 40 having a first outer periphery 42 at least partially defining a first shape. As shown in FIGS. 1 and 2, a first removable panel 44 is formed or cut within the first shape of first side portion 40 on face sheet 20. First removable panel 44 is removable with respect to first side portion 40 to form a first void 46, as shown in FIG. 3, within outer periphery 42 of first side portion 40. An outer periphery or shape of first removable portion 44 preferably corresponds to a perimeter or shape of first void 46. Preferably, first removable panel 44 is removed as label 30 is removed from back sheet 18 and separated from carrier portion 25. Alternatively, first removable panel 44 can be removed before or after label 30 is removed from back sheet 18.

Label 30 includes a second side portion 60 having a second outer periphery 62 at least partially defining a second shape. A second removable panel 64 is formed or cut within the second shape of second side portion 60 on face sheet 20. Second removable panel 64 is removable with respect second side portion 60 to form a second void 66, as shown in FIG. 3, within second outer periphery 62. An outer periphery or shape of second removable portion 64 preferably corresponds to a perimeter or shape of second void 66. Like first removable panel 44, second removable panel 64 is preferably removed as label 30 is removed from back sheet 18 and separated from carrier portion 25. Alternatively, second removable panel 64 can be removed before or after label 30 is removed from back sheet 18.

In one preferred embodiment of this invention, first removable panel 44 has one of a circular shape, an elliptical shape and a polygonal shape and second removable panel 64 has a shape corresponding to the shape of first removable panel 44 such that an outer periphery of first removable panel 44 corresponds to an outer periphery of second removable panel 64. It is apparent to those skilled in the art that each removable panel can have any suitable shape that results in the formation of a void having a suitable size and/or dimensions when the removable panel is removed from the respective side portion.

As shown in FIGS. 1-4, label 30 includes a fold line 70 at least partially defining each of first side portion 40 and second side portion 60. Fold line 70 is positioned between first side portion 40 and second side portion 60 and defines a boundary therebetween. Preferably, fold line 70 is formed of a die cut line, a laser die cut line, a score cut line, a perforation line, a microperforation line, a chemically etched line, a liquid etched line, a gas etched line and combinations thereof. Second side portion 60 is foldable along fold line 70 with respect to first side portion 40 to form label 30. After label 30 is removed from back sheet 18, an adhesive coating at least partially covers a back surface of label 30 so that a back surface of first side portion 40 can be adhesively bonded or adhered to a back surface of second side portion 60.

Preferably, but not necessarily, with label 30 in a folded position, second outer periphery 62 is generally coextensive with first outer periphery 42. Further, with label 30 in the folded position, first void 46 is generally aligned with second void 66. With first void 46 aligned with second void 66, label 30 is positionable about a neck portion of a wine bottle. As discussed above, label 30 made according to the present invention can be positioned about a neck portion of the wine bottle to identify the contents of the bottle and any desired information regarding the purchase of the bottle and/or relevant information pertaining to such facts as the maker of the wine, the year in which the wine was produced, the purchase price, an inventory number and/or a year the bottle was acquired.

As shown in FIG. 1, first side portion 40 includes at least one first printable surface 48. For example, one first printable surface 48 may be positioned above first removable panel 44 and one first printable surface 48 can be position below first removable panel 44, as shown in FIG. 1. First printable surface 48 can have any suitable shape and/or dimensions in order to print on first side portion 40 any desired information including an image or a picture as well as identifying text and/or corresponding inventory numbers, for example.

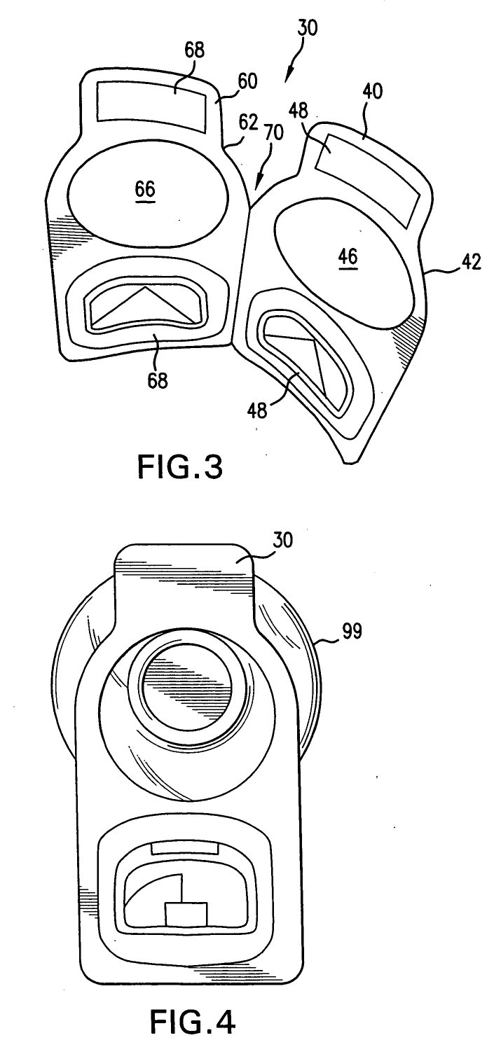

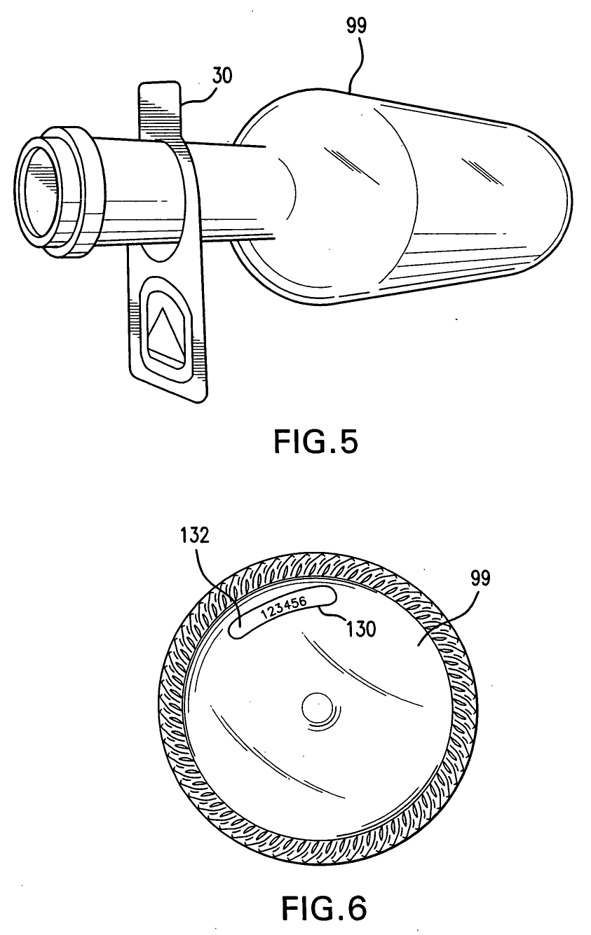

Similarly, second side portion 60 preferably includes at least one second printable surface 68 on which any desired information can be printed. As shown in FIG. 1, one second printable surface 68 may be positioned above second removable panel 64 and one second printable surface 68 can be position below second removable panel 64, for example. The information printed on second printable surface 68 can include the same information printed on first printable surface 68 or can include additional or different information, as desired by the user. Referring to FIGS. 4 and 5, with label 30 in the folded position, first printable surface 48 is in an opposing relationship with or opposite second printable surface 68.

Label 30 can include a removable section or a removed section positioned about the void formed in label 30, to slidably position label 30 about an object. For example, label 30 including a removable section or a removed section can be slidably positioned about a stem of a wine glass at a party and include a name and/or photograph indicating or identifying the person using the glass. As shown in FIG. 1, in one preferred embodiment of this invention, label 30 includes a removable section including a first removable section 80 formed in first side portion 40 and a second removable section 90 formed in second side portion 60. The removable section can be positioned at any suitable position about the void formed in label 30. For example, the removable section can be positioned near fold line 70 or at an opposite side of label 30 with respect to fold line 70. First removable section 80 extends between first outer periphery 42 and a perimeter of first removable panel 44 corresponding to first void 46. A corresponding second removable section 90 extends between second outer periphery 62 and a perimeter of second removable panel 64 corresponding to second void 66. With label 30 in the folded position, first removable section 80 is generally aligned with second removable section 90. First removable section 80 is preferably defined or formed by two corresponding tearable lines of separation 82 and second removable section 90 is preferably defined or formed by two corresponding tearable lines of separation 92, as shown respectively in FIG. 1. Tearable lines of separation 82 preferably extend between first outer periphery 42 and a perimeter of first void 46 to define first removable section 80. Similarly, tearable lines of separation 92 preferably extend between second outer periphery 62 and a perimeter of second void 66 to define second removable section 90.

As used throughout this specification and in the claims, the term tearable lines of separation relates to separation lines that can be torn to separate the removable sections 80, 90 from label 30 after label 30 has been removed from back sheet 18, if desired. Tearable lines of separation can be formed of a die cut line, a laser die cut line, a score cut line, a perforation line, a microperforation line, a chemically etched line, a liquid etched line, a gas etched line and combinations thereof or any other suitable separation line.

In another preferred embodiment of this invention, label 30 includes an opening formed in label 30 about a perimeter of the label void. The opening is preferably formed by a first opening 85 formed in first side portion 40 and a second opening 95 formed in second side portion 60. The opening can be positioned at any suitable position about the void formed in label 30. For example, the opening can be positioned near fold line 70 or at an opposite side of label 30 with respect to fold line 70. First opening 85 is formed between first outer periphery 42 and a perimeter of first removable panel 44 corresponding to first void 46, as shown in FIG. 1. With label 30 removed from back sheet 18 and with respect to carrier portion 25, first opening 85 communicates with first void 46. Second opening 95 is formed between second outer periphery 62 and a perimeter of second removable panel 64 corresponding to second void 66, as shown in FIG. 1. With label 30 removed from back sheet 18 and with respect to carrier portion 25, second opening 95 communicates with second void 66. With label 30 in the folded position, first opening 85 is generally aligned with second opening 95.

In one preferred embodiment of this invention, label 30 includes a plurality of slits each extending radially outwardly from the void formed in label 30. Preferably, the slits extend radially outwardly from at least one of the perimeter of first void 46 and the perimeter of second void 66. As shown in FIG. 1, a plurality of first slits 97 are formed in first side portion 40 and extend radially outwardly about the perimeter of first void 46. Similarly, a plurality of second slits 98 are formed in second side portion 60 and extend radially outwardly about the perimeter of second void 66. With label 30 in the folded position, first slits 97 formed on first side portion 40 are aligned with second slits 98 formed on second side portion 60.

In one preferred embodiment of this invention, label assembly 10 includes at least one second label 130. Preferably, label assembly 10 includes a plurality of second labels 130, as shown in FIG. 1. Second label 130 can have any size and/or dimensions suitable for the intended use of second label 130. Each second label 130 includes a printable surface 132 on which information can be printed. For example, information corresponding to or relating to the information contained on label 30 can be included on printable surface 132. Alternatively, or in addition, different information, such as an inventory number or stock number, can be printed on second label 130. A line of separation 136 is formed in face sheet 20 and defines an outer periphery of second label 130. Preferably, line of separation 136 is die-cut along the outer periphery of second label 130. Second label 130 is removable from back sheet 18 and separable from carrier portion 25 at line of separation 136. After second label 130 is removed from back sheet 18, second label 130 can be adhesively attached to an object. For example, as shown in FIG. 6, second label 130 can be adhered to a bottom surface of a wine bottle. A serial number, inventory number or stock number, for example, can be printed or written on printable surface 132 to identify the wine bottle if a corresponding label 30 is missing or removed from the neck portion of the bottle.

In making label 30 according to one preferred embodiment of this invention, label assembly 10 is routed through a suitable printer. Information downloaded from an internet website or saved on a computer database for example, is printed on at least one printable surface 48 of the first side portion 40 and/or on at least one printable surface 68 of second side portion 60 of label 30. For example, in one preferred embodiment of this invention, a first set of information, such as including an image, is printed on first printable surface 48 of first side portion 40. In one preferred embodiment of this invention, a database containing or having a plurality of downloadable images is accessible from a personal computer or work station. At least one of the downloadable images can be selected to download. After the image is downloaded, the image is printed on first side portion 40 and/or second side portion 60.

Additionally, or alternatively, a second set of information is printed on second printable surface 68 of second side portion 60. The first set of information may be the same or similar to the second set of information, or may contain different information. Additionally, or alternatively, a third set of information can be printed on printable surface 132 of second label 130. The third set of information can be the same or related to the first set of information and/or the second set of information, or can contain different information. As used in the specification and in the claims, the term information refers to any suitable or desirable electronic image, such as a digital photograph, picture, drawing, text and/or symbol.

After label assembly 10 is routed through the printer to print on label 30 the desired or selected information, label 30 is separated from carrier portion 25 along line of separation 26 formed between label 30 and carrier portion 25. Label 30 is removed from back sheet 18 with the adhesive layer initially positioned between back sheet 18 and face sheet 20 adhering substantially to a back surface of label 30. Thus, the adhesive coating at least partially covers the back surface of label 30. Preferably, as label 30 is removed from back sheet 18, first removable panel 44 is removed from first side portion 40 to form first void 46 and second removable panel 64 is removed from second side portion 60 to form second void 66. First removable panel 44 is preferably cut within a perimeter of first side portion 40 on face sheet 20, and second removable panel 64 is preferably cut within a perimeter of second side portion 60 on face sheet 20. In certain embodiments of this invention, first removable panel 44 and/or second removable panel 64 can be removed from label 30 before or after label 30 is removed from back sheet 18.

Second label 130 can also be removed from label assembly 10. Second label 130 can be separated from carrier portion 25 and removed from back sheet 18 and with respect to carrier portion 25 along line of separation 136. Second label 130 is removed from back sheet 18 with the adhesive layer initially positioned between back sheet 18 and face sheet 20 adhering substantially to a back surface of second label 130. Thus, the adhesive coating at least partially covers the back surface of second label 130. Second label 130 can then be adhered to a surface, such as a bottom surface of a wine bottle.

Label 30 is folded along fold line 70 positioned between first side portion 30 and second side portion 40 with first void 46 formed in first side portion 40 generally aligned with second void 66 formed in second side portion 60. With label 30 in the folded position, the back surface of first side portion 40 can be adhesively bonded or adhered to the back surface of second side portion 60 by applying a suitable pressure to label 30. With label 30 folded along fold line 70, first outer periphery 42 of first side portion 40 is preferably coextensive with second outer periphery 62 of second side portion 60.

In one preferred embodiment of this invention, first removable section 80 is aligned with second removable section 90 as the first void is aligned with the second void. First removable section 80 is defined between two tearable lines of separation 82 each extending between first outer periphery 42 and the perimeter of first void 46. Second removable section 90 is defined between two tearable lines of separation 92 each extending between second outer periphery 62 and the perimeter of second void 66. First removable section 80 is removed from first side portion 40. Second removable section 90 is removed from second side portion 60. First removable section 80 and/or second removable section 90 can be removed before or after second side portion 60 is folded with respect to first side portion 40 to form label 30. In certain embodiments of this invention, each slit 97 formed in first side portion 40 is aligned with a corresponding slit 98 formed in second side portion 60. For example, first side portion 40 preferably, but not necessarily, includes a plurality of slits 97 extending radially outwardly from the perimeter of first void 46. Similarly, second side portion 60 includes a plurality of slits 98 extending radially outwardly from the perimeter of second void 66 and corresponding generally to slits 97.

In another preferred embodiment of this invention, first opening 85 is formed between first outer periphery 42 of first side portion 40 and the perimeter of first void 46. Preferably, first opening 85 is formed as label 30 is removed from back sheet 18. With label 30 removed from back sheet 18 and separated from carrier portion 25, first opening 85 communicates with first void 46. Preferably, second opening 95 is formed between second outer periphery 62 and the perimeter of second void 66. A position of second opening 95 with respect to the perimeter of second void 66 preferably corresponds to a position of first opening 85 with respect to the perimeter of first void 46. With label 30 removed from back sheet 18 and separated from carrier portion 25, second opening 95 communicates with second void 66. With label 30 in the folded position, first opening 85 is generally aligned with second opening 95.

While in the foregoing specification this invention has been described in relation to certain preferred embodiments thereof, and many details have been set forth for purpose of illustration, it will become apparent to those skilled in the art that the invention is susceptible to additional embodiments and that certain of the details described herein can be varied considerably without departing from the basic principles of the invention. Therefore, to particularly point out and distinctly claim the subject matter regarded as the invention, the following claims conclude the specification.

We claim:

1. A method for making a label comprising:
routing a label assembly including a back sheet and a face sheet through a printer, the face sheet having a carrier portion and at least one label;
printing information on a first printable surface of a first side portion of the at least one label;
separating the at least one label from the carrier portion along a line of separation formed between the at least one label and the carrier portion and removing the at least one label from the back sheet; and
folding the at least one label along a fold line positioned between the first side portion and a second side portion of the at least one label, a first void formed in the first side portion generally aligned with a second void formed in the second side portion.

2. The method of claim 1 further comprising:
removing a first removable panel from the first side portion to form the first void; and
removing a second removable panel from the second side portion to form the second void.

3. The method of claim 1 further comprising:
printing information on a second printable surface of the second side portion of the at least one label before separating the label from the carrier portion.

4. The method of claim 1 further comprising:
adhering a back surface of the first side portion to a back surface of the second side portion.

5. The method of claim 1 further comprising:
downloading an image from an internet website; and
printing the image on at least one of the first side portion and the second side portion.

6. The method of claim 1 further comprising:
printing corresponding information on a printable surface of a second label;
separating the second label from the carrier portion along a line of separation formed between the second label and the carrier portion;
removing the second label from the back sheet; and
adhering the second label to a surface.

7. The method of claim 1 wherein when the label is folded along the fold line, a first outer periphery of the first side portion is coextensive with a second outer periphery of the second side portion.

8. The method of claim 1 further comprising:
aligning a first removable section extending between a first outer periphery of the first side portion and a first perimeter of the first void with a second removable section extending between a second outer periphery of the second side portion and a second perimeter of the second void.

9. The method of claim 1 further comprising:
removing a first removable section from the first side portion, the first removable section defined between two lines of separation each extending between a first outer periphery of the first side portion and a first perimeter of the first void;
removing a second removable section from the second side portion, the second removable section defined between two lines of separation each extending between a second outer periphery of the second side portion and a second perimeter of the second void; and
aligning the first removable section with the second removable section as the first void is aligned with the second void.

10. The method of claim 9 wherein each of the first removable section and the second removable section is removed as the label is separated from the carrier portion.

11. The method of claim 1 further comprising:
forming a plurality of slits extending radially outwardly from at least one of a first perimeter of the first void and a second perimeter of the second void.

12. A method for making a label comprising:
routing a label assembly comprising a back sheet and a face sheet through a printer, the face sheet having a carrier portion and at least one label;
printing an image on a first side portion of the at least one label;
printing information on a second side portion of the at least one label;
separating the label from the carrier portion along a line of separation formed between the at least one label and the carrier portion and removing the at least one label from the back sheet; and
folding the at least one label along a fold line positioned between the first side portion and a second side portion of the at least one label, a first void formed in the first side portion generally aligned with a second void formed in the second side portion.

13. The method of claim 12 further comprising:
removing a first removable panel from the first side portion to form the first void; and
removing a second removable panel from the second side portion to form the second void.

14. The method of claim 12 further comprising:
forming a first opening between a first outer periphery of the first side portion and a first perimeter of the first void, the first opening communicating with the first void; and
forming a second opening between a second outer periphery of the second side portion and a second perimeter of the second void, the second opening communicating with the second void; and
aligning the first opening with the second opening.

15. A method for making a label comprising:
routing a label assembly comprising a back sheet and a face sheet through a printer, the face sheet having a carrier portion and at least one label;
printing an image on a first side portion of the at least one label;
printing information on a second side portion of the at least one label;
separating the at least one label from the carrier portion along a line of separation formed between the at least one label and the carrier portion and removing the at least one label from the back sheet;
forming a first void within a first outer periphery of the first side portion;
forming a first opening between the first outer periphery and a first perimeter of the first void, the first opening communicating with the first void;
forming a second void within a second outer periphery of the second side portion;
forming a second opening between the second outer periphery and a second perimeter of the second void, the second opening communicating with the second void; and
folding the at least one label along a fold line positioned between the first side portion and the second side portion, aligning the first void with the second void and aligning the first opening with the second opening.

16. The method of claim 15 further comprising:
accessing a database having a plurality of downloadable images;
selecting at least one downloadable image to download;
downloading the selected image; and
printing the image on at least one of the first side portion and the second side portion.

17. The method of claim 15 wherein the first void is formed by removing a first removable panel cut within a first space at least partially defined by the first side portion on the face sheet, and the second void is formed by removing a second removable panel cut within a second space at least partially defined by the second side portion on the face sheet.

18. The method of claim 15 wherein the first opening is formed by removing a first removable section from the first side portion, and the second opening is formed by removing a second removable section from the second side portion.

19. The method of claim 18 wherein the first removable section and the second removable section are removed as the at least one label is removed from the back sheet.

20. The method of claim 18 wherein the first removable section and the second removable section are removed after the label is folded.
